(19) United States
(12) Patent Application Publication
(10) Pub. No.: US 2006/0109807 A1
(43) Pub. Date: May 25, 2006

(54) Multicasting using tunneling method

(76) Inventor: Min-Kyu Lee, Suwon-si (KR)

Correspondence Address: Robert E. Bushnell, Suite 300, 1522 K Street, N.W., Washington, DC, 20005-1202, US

(21) Appl. No.: 11/271,861

(22) Filed: Nov. 14, 2005

(30) Foreign Application Priority Data
Nov. 24, 2004 (KR) 2004-97146

(51) Int. Cl. H04J 3/08; H04B 7/14; H04J 1/10

(52) U.S. Cl. 370/315

(57) ABSTRACT

A tunneling method includes: managing a session entry table for storing information used for multicasting data transmitted from a first network having a first address format to a second network having a second address format different from the first address format; and tunneling multicasting data, generated by the first network, to the second network in accordance with the session entry table. Furthermore, a tunneling apparatus includes: a first interface adapted to interface with a first network having a first address format; a second interface adapted to interface with a second network having a second address format; a session entry table adapted to store information used for multicasting data transmitted from the first network to the second network; a table manager adapted to add a new entry, and to update and delete information of a previously stored old entry, with respect to the session entry table in accordance with information of the data transmitted and received via the first and second interfaces; an encapsulator adapted to encapsulate data of the first address format into data of the second address format to transmit the data from the first network to the second network; and a packet parser adapted to determine whether or not the data received via the first interface is multicasting data, and controlling the encapsulator and the table manager in accordance with the determination result.

### CLAIM OF PRIORITY

This application makes reference to, incorporates the same herein, and claims all benefits accruing under 35 U.S.C. § 119 from an application for TUNNELING METHOD AND APPARATUS FOR MULTICASTING earlier filed in the Korean Intellectual Property Office on Nov. 24, 2004 and there duly assigned Ser. No. 10-2004-0097146.

### BACKGROUND OF THE INVENTION

1. Field of the Invention

The present invention relates generally to multicasting using a tunneling method, and, more particularly, to a method and apparatus to generate multicasting address information with reference to a session entry table.

2. Description of the Related Art

In using a Transmission Control Protocol/Internet Protocol (TCP/IP) as an internetworking protocol, a network layer IP protocol is currently operated with Internet Protocol version 4 (IPv4). IPv4 provides host-to-host communication between systems on the Internet. Although IPv4 is well designed, drawbacks have been discovered which make it inadequate for Internet data communication developed since the introduction of IPv4 (i.e., in the 1970s).

Hence, in order to overcome these drawbacks, Internet Protocol version 6 (IPv6) has been proposed, which is otherwise known as “Internet Protocol next generation” (IPng) and has become a standard at present. Many parts of IPv6 have been corrected to deal with Internet developments. For example, the format and length of an IP address has been changed together with a packet format, its related protocols (e.g., Internet Control Message Protocol (ICMP), etc.) have been corrected, and other protocols such as Address Resolution Protocol (ARP), Reverse Address Resolution Protocol (RARP) and Internet Group Management Protocol (IGMP) have been deleted or added to ICMP. Furthermore, routing protocols, e.g., Routing Information Protocol (RIP) and Open Shortest Path First (OSPF), have been slightly corrected to cope with these changes.

In this manner, IPv6 has been become a current standard. Accordingly, systems operating with IPv6 are gradually being developed. However, an enormous number of systems are provided for the Internet, so that the transition from IPv4 to IPv6 cannot be carried out rapidly. In other words, it will take a long time for all of the systems on the Internet to change from IPv4 to IPv6. Thus, the transition is gradually being carried out to prevent a problems between IPv4 based systems and IPv6 based systems.

Strategies devised by the Internet Engineering Task Force (IETF) include a method of using a dual stack, a header translation method, and a tunneling method.

In the method of using the dual stack, all of the hosts have a dual stack protocol before being completely transited to IPv6. In other words, in this method, all of the systems of the Internet operate in both IPv4 and IPv6 at the same time until all of the systems use IPv6.

The header translation method is effective for the case where most of the Internet systems use IPv6, but some of the Internet systems still use IPv4. In other words, in this method, when a sender wants to use IPv6 and a receiver cannot understand IPv6, a header of an IPv6 packet is translated into that of an IPv4 packet, and then transmitted.

The tunneling method is used when two computers using IPv6 intend to communicate with each other and pass through a region where IPv4 is used. In other words, in this method, an IPv6 packet is encapsulated in an IPv4 packet on entering the region where IPv4 is used, and then decapsulated on leaving the region where IPv4 is used.

In a 6 to 4 tunneling process in a IPv6 transition network, a first IPv6 host, connected to a first IPv6 network A, transmits data to a second IPv6 host, connected to a second IPv6 network C, for example, and the second IPv6 network C is connected via a first IPv4 network B.

The first IPv6 host transmits the first data encapsulated by IPv6 to the first IPv6 network A, and a first IPv6 transit router, which is arranged at the boundary between the first IPv6 network A and the first IPv4 network B, encapsulates the first data by means of IPv4 and transmits the data to a second IPv6 transit router. The first data is transmitted to the first IPv4 network B with a header of an IPv4 packet added thereto, thereby becoming second data. The second IPv6 transit router receiving the second data encapsulated by IPv4 decapsulates the second data and transmits the second data to the second IPv6 network C. The second data is transmitted to the second IPv6 network C with the IPv4 packet header removed threrefrom in order to pass through the first IPv4 network B, thereby becoming third data. The second IPv6 host receives the third data from which the IPv4 packet header is removed.

The second IPv6 transit router decapsulates the received data and transmits the decapsulated data to the second IPv6 network C. The second IPv4 encapsulated data are transmitted to the second IPv6 network C after the IPv4 packet header has been removed therefrom.

Then, the second IPv6 host 20 receives third data 53a from which the IPv4 packet header has been removed.

In this manner, typically, when the 6 to 4 tunneling process is performed, the IPv4 encapsulation is performed by using the IPv4 address information included in the IPv6 address. Hence, in order to perform the IPv4 encapsulation, the IPv4 address must be included in the IPv6 address.

However, the data to be multicast in the IPv6 network includes only a multicast address promised in advance without including the IPv4 address in the destination address. Thus, if the destination address is the multicast address on performing the 6 to 4 tunneling process, the IPv4 encapsulation is impossible. Consequently, there is a drawback in that the IPv6 protocol using the multicast address, for example, Routing Information Protocol next generation (RIPng), Open Shortest Path First v3 (OSPFv3), Protocol Independent Multicast (PIM), Distance Vector Multicast Routing Protocol (DVMRP), Resource ReServation Protocol (RSVP) etc. can not be used with a 6 to 4 tunnel. In other words, when data transmission between the IPv6 and IPv4 networks is performed by using the 6 to 4 tunneling method, there is drawback in that multicasting is impossible

In a multicasting IPv6 transit network, when a IPv6 host connected to an IPv6 network A intends to multicast data to a plurality of other IPv6 hosts connected to the IPv6 host via an IPv4 network B, an IPv6 transit router arranged at the boundary between the IPv6 network A and the IPv4 network B transmits the multicast data from the IPv6 host to an IPv6 transit router and an IPv6 transit router. As mentioned above, the multicast data does not include IPv4 addresses (i.e., the addresses of the IPv6 hosts respectively connected via the IPv6 transit router and the IPv6 transit router). Therefore, there is a drawback in that the IPv6 host cannot perform the multicasting using the 6 to 4 tunneling method.

### SUMMARY OF THE INVENTION

An object of the present invention is to provide a tunneling method and apparatus to generate address information for multicasting with reference to a session entry table.

Furthermore, another object of the present invention is to provide a method and apparatus to enable multicasting to be performed in an IPv6 transition network by a 6 to 4 tunneling method.

According to an aspect of the present invention, a method is provided comprising: managing a session entry table for storing information used for multicasting data transmitted from a first network having a first address format to a second network having a second address format different from the first address format; and tunneling multicasting data, generated by the first network, to the second network in accordance with the session entry table.

Managing the session entry table preferably comprises detecting second address format source addresses of packet data and storing the detected second address format addresses in the session entry table upon a router arranged on a boundary between the first network and the second network receiving the packet data from the second network.

Managing the session entry table preferably comprises storing together lifetimes of hosts corresponding to the second address format addresses in the session entry.

Managing the session entry table preferably comprises setting default values of the lifetimes in accordance with a value of a hello packet transmission period or an update period and a value of a hold time or an expiration timeout with respect to a multicasting protocol.

Managing the session entry table preferably comprises setting the default values of the lifetimes within a range greater than the hello packet transmission period or the update period and smaller than the hold time or the expiration timeout.

Managing the session entry table preferably comprises setting the default values of the lifetimes to the value of the hold time or the expiration timeout.

Managing the session entry table preferably comprises decreasing the lifetimes by periods, and deleting a corresponding entry from the session entry table upon the lifetimes having a value of ‘0(zero)’.

Managing the session entry table preferably comprises updating lifetimes corresponding to the source addresses to default values upon the detected source addresses already existing in the session entry table.

Tunneling the multicasting data preferably comprises encapsulating the multicasting data by the number of entries included in the session entry table by adopting each of the second address format addresses stored in the session entry table as a destination address, and then multicasting each of the encapsulated data to the corresponding format address.

According to another aspect of the present invention, a method is provided comprising: managing a 6 to 4 session entry table for storing information used for multicasting data transmitted from an Internet Protocol version 6 (IPv6) network to an Internet Protocol version 4 (IPv4) network; and tunneling the multicasting data to the IPv4 network in accordance with the 6 to 4 session entry table upon multicasting data being generated by the IPv6 network.

Managing the 6 to 4 session entry table preferably comprises detecting IPv4 source addresses of packet data and storing the detected IPv4 addresses in the 6 to 4 session entry table upon a router arranged on a boundary between the IPv6 network and the IPv4 network receiving the packet data from the IPv4 network.

Managing the 6 to 4 session entry table preferably comprises storing together lifetimes of hosts corresponding to the IPv4 addresses in the 6 to 4 session entry.

Managing the 6 to 4 session entry table preferably comprises setting default values of the lifetimes in accordance with a value of a hello packet transmission period or an update period and a value of a hold time or an expiration timeout with respect to a multicasting protocol.

Managing the 6 to 4 session entry table preferably comprises setting the default values of the lifetimes within a range greater than the hello packet transmission period or the update period and smaller than the hold time or the expiration timeout.

Managing the 6 to 4 session entry table preferably comprises setting the default values of the lifetimes to the value of the hold time or the expiration timeout.

Managing the 6 to 4 session entry table preferably comprises decreasing the lifetimes by periods and deleting a corresponding entry from the 6 to 4 session entry table upon the lifetimes having a value of ‘0(zero)’.

Managing the 6 to 4 session entry table preferably comprises updating lifetimes corresponding to the IPv4 addresses to default values upon the detected IPv4 addresses already existing in the 6 to 4 session entry table.

Tunneling the multicasting data preferably comprises performing IPv4 encapsulation of the multicasting data by the number of entries included in the 6 to 4 session entry table by adopting each of the IPv4 addresses stored in the 6 to 4 session entry table as a destination address, and then multicasting each of the IPv4 encapsulated data to the corresponding IPv4 address.

According to still another aspect of the present invention, an apparatus is provided comprising: a first interface adapted to interface with a first network having a first address format; a second interface adapted to interface with a second network having a second address format; a session entry table adapted to store information used for multicasting data transmitted from the first network to the second network; a table manager adapted to add a new entry, and to update and delete information of a previously stored old entry, with respect to the session entry table in accordance with information of the data transmitted and received via the first and second interfaces; an encapsulator adapted to encapsulate data of the first address format into data of the second address format to transmit the data from the first network to the second network; and a packet parser adapted to determine whether or not the data received via the first interface is multicasting data, and controlling the encapsulator and the table manager in accordance with the determination result.

The session entry table preferably comprises a field for addresses of the second address format that are source addresses of the data received via the second interface, and a lifetime field for lifetimes of hosts corresponding to the addresses.

The lifetime field is preferably adapted to store values set in accordance with a value of a hello packet transmission period or an update period and a value of a hold time or an expiration timeout with respect to a multicasting protocol, the set values being stored as default values of the lifetimes.

The lifetime field is preferably adapted to store values set within a range greater than the hello packet transmission period or the update period and smaller than the hold time or the expiration timeout, the set values being stored as default values of the lifetimes.

The lifetime field is preferably adapted to store the value of the hold time or the expiration timeout as the default value of the lifetime.

The table manager is preferably adapted to decrease the lifetimes stored in the lifetime field by periods and delete a corresponding entry from the session entry table upon the lifetimes having a value of ‘0(zero)’.

The table manager is preferably adapted to detect the source addresses from the data received via the second interface, and to add the detected source addresses and the lifetimes of hosts corresponding to the source addresses to the session entry table.

The table manager is preferably adapted to detect the source addresses from the data received via the second interface and to update lifetimes corresponding to the source addresses to default values upon the detected source addresses already existing in the session entry table.

The packet parser is preferably adapted to parse destination addresses of the data received via the first interface to determine whether or not the received data is multicasting data.

The packet parser is preferably adapted to control operation of the table manager to allow the table manager to detect all of the addresses stored in the session entry table from the session entry table and to then transmit the addresses to the encapsulator upon the data received via the first interface being multicasting data,.

The encapsulator is preferably adapted to generate encapsulation data adopting all of the addresses transmitted via the table manager as the destination addresses with respect to the transmitted addresses and to transmit the generated encapsulation data to the second interface.

According to yet another aspect of the present invention, an apparatus is provided comprising: a first interface adapted to interface with an Internet protocol version 6 (IPv6) network; a second interface adapted to interface with an Internet protocol version 4 (IPv4) network; a 6 to 4 session entry table adapted to store information used for multicasting data transmitted from the IPv6 network to the IPv4 network; a table manager adapted to add a new entry and update and delete information of a previously stored old entry, with respect to the 6 to 4 session entry table in accordance with information of the data transmitted and received via the first and second interfaces; an encapsulator adapted to encapsulate data of an IPv6 format into data of an IPv4 format to transmit the data from the IPv6 network to the IPv4 network; and a packet parser adapted to determine whether or not the data received via the first interface is multicasting data, and to control the encapsulator and the table manager in accordance with the determination result.

The 6 to 4 session entry table preferably comprises an address field adapted to store the IPv4 addresses that are source addresses of the data received through the second interface, and a lifetime field for lifetimes of hosts corresponding to the IPv4 addresses.

The lifetime field is preferably adapted to store values set in accordance with a value of a hello packet transmission period or an update period and a value of a hold time or an expiration timeout with respect to a multicasting protocol, the set values being stored as default values of the lifetimes.

The lifetime field is preferably adapted to store values set within a range greater than the hello packet transmission period or the update period and smaller than the hold time or the expiration timeout, the set values being stored as the default values of the lifetimes.

The lifetime field is preferably adapted to store the value of the hold time or the expiration timeout as the default value of the lifetime.

The table manager is preferably adapted to decrease the lifetimes stored in the lifetime field by periods and to delete a corresponding entry from the 6 to 4 session entry table upon the lifetimes having a value of ‘0(zero)’.

The table manager is preferably adapted to detect the IPv4 addresses of sources from the data received via the second interface, and to add the detected IPv4 addresses and the lifetimes of hosts corresponding to the IPv4 addresses to the 6 to 4 session entry table.

The table manager is preferably adapted to detect the IPv4 addresses of the sources from the data received via the second interface and to update lifetimes corresponding to the IPv4 addresses to default values upon the detected IPv4 addresses already existing in the 6 to 4 session entry table.

The packet parser is preferably adapted to parse destination addresses of the data received via the first interface to determine whether or not the received data is multicasting data.

The packet parser is preferably adapted to control operation of the table manager to allow the table manager to detect all of the IPv4 addresses stored in the 6 to 4 session entry table from the 6 to 4 session entry table and then transmit the IPv4 addresses to the encapsulator upon the data received via the first interface being multicasting data.

The encapsulator is preferably adapted to generate encapsulation data adopting all of the IPv4 addresses transmitted via the table manager as the destination addresses with respect to the transmitted IPv4 addresses and to transmit the generated encapsulation data to the second interface.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a view of a 6 to 4 tunneling process in a IPv6 transition network;

FIG. 2 is a more detailed view of a 6 to 4 tunneling process in a IPv6 transition network;

FIG. 3 is a view of multicasting in a IPv6 transit network;

FIG. 4 is a 6 to 4 session entry table according to an embodiment of the present invention;

FIGS. 5A and 5B are views for explaining a tunneling method and apparatus for multicasting in an IPv6 transition network in accordance with one embodiment of the present invention, respectively;

FIG. 6 is a flowchart of processing a corresponding IPv6 transit router in order to generate and manage an entry table;

FIG. 7 is a view for explaining in more detail a process of generating and managing a 6 to 4 session entry table of the present invention in an OSPFv3 protocol;

FIGS. 8A and 8B are examples of a 6 to 4 session entry table generated in the example of FIG. 7; and

FIG. 9 is a block diagram of a multicasting apparatus in an IPv6 transition network according to one embodiment of the present invention.

### DETAILED DESCRIPTION OF THE INVENTION

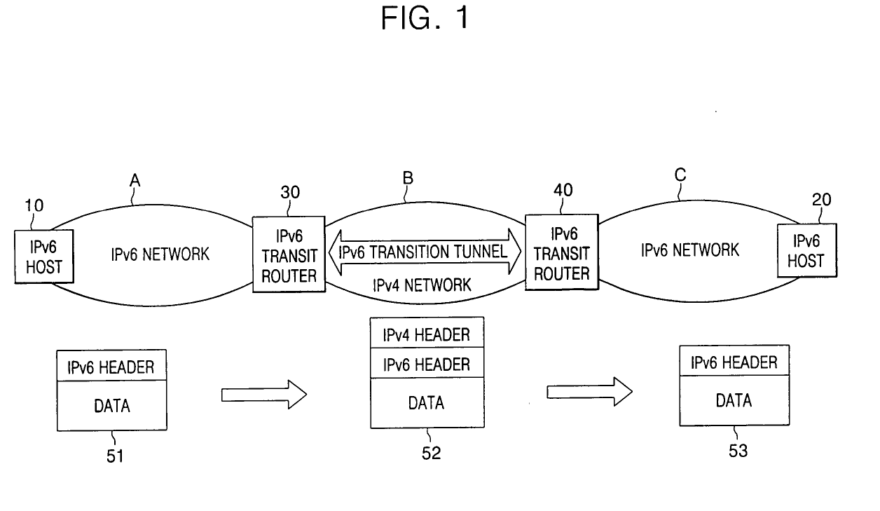

FIG. 1 is a view of a 6 to 4 tunneling process in a IPv6 transition network, wherein a first IPv6 host 10, connected to a first IPv6 network A, transmits data to a second IPv6 host 20, connected to a second IPv6 network C, for example, and wherein the second IPv6 network C is connected via a first IPv4 network B.

Referring to FIG. 1, the first IPv6 host 10 transmits the first data 51 encapsulated by IPv6 to the first IPv6 network A, and a first IPv6 transit router 30, which is arranged at the boundary between the first IPv6 network A and the first IPv4 network B, encapsulates the first data 51 by means of IPv4 and transmits the data to a second IPv6 transit router 40. The first data 51 is transmitted to the first IPv4 network B with a header of an IPv4 packet added thereto, thereby becoming second data 52. The second IPv6 transit router 40 receiving the second data 52 encapsulated by IPv4 decapsulates the second data 52 and transmits the second data 52 to the second IPv6 network C. The second data 52 is transmitted to the second IPv6 network C with the IPv4 packet header removed threrefrom in order to pass through the first IPv4 network B, thereby becoming third data 53. The second IPv6 host 20 receives the third data 53 from which the IPv4 packet header is removed.

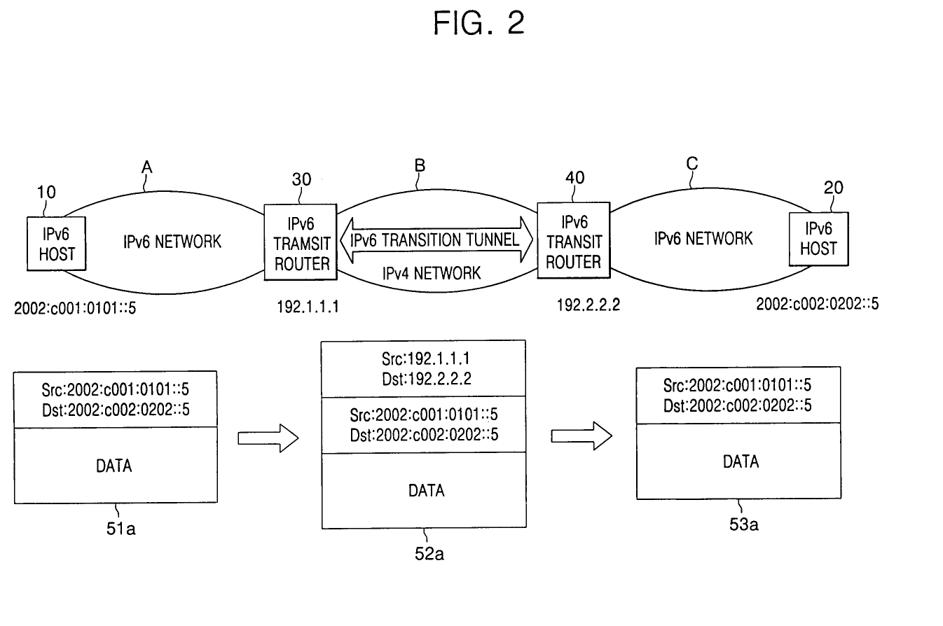

FIG. 2 is a more detailed view of a 6 to 4 tunneling process in a IPv6 transition network. FIG. 2 shows the case where, in the example of FIG. 1, the first IPv6 host 10 has an IPv6 address of 2002:c001:0101::5, and the second IPv6 host 20 has an IPv6 address of 2002:c002:0202::5 by way of an example. In other words, FIG. 2 shows the 6 to 4 tunneling process in the case where the first IPv6 host 10 having the IPv6 address of 2002:c001:0101::5 transmits the data to the second IPv6 host 20 having the IPv6 address of 2002:c002:0202::5 via the first IPv4 network B.

Referring to FIG. 2, the first IPv6 host 10 performs IPv6 encapsulation by adding an IPv6 packet header to data intended for transmission. The IPv6 packet header includes an address of a source Src from which the corresponding data has been transmitted, and an address of a destination Dst at which the transmitted data is received. In the example of FIG. 2, the source of the data to be transmitted is the first IPv6 host 10, and the destination is the second IPv6 host 20. Hence, the address, 2002:c001:0101::5, of the first IPv6 host 10 and the address, 2002:c002:0202::5, of the second IPv6 host 20 are included in the IPv6 packet header of the first data 51a generated by IPv6 encapsulation. The first IPv6 host 10 transmits the first data 51a undergoing the IPv6 encapsulation to the first IPv6 network A.

Then, the first IPv6 transit router 30 performs IPv4 encapsulation by adding an IPv4 packet header to the first data 51a. The IPv4 packet header is generated on the basis of information on the source and destination addresses included in the IPv6 packet header of the data 51a. In other words, the IPv4 packet header is generated by using information on an IPv4 address included in the source and destination addresses of an IPv6 format included in the IPv6 packet header. The IPv4 address information is included in second and third columns of the IPv6 addresses, and is used by converting values of the columns into decimal numbers.

In the example of FIG. 2, since the source address of the first data 51a is 2002:c001:0101::5, the values, c001 and 0101, of the second and third columns, are extracted and converted into the decimal numbers, 192.1.1.1, of two figures. In the example of FIG. 2, since the destination address of the first data 51a is 2002:c002:0202::5, the values, c002 and 0202, of the second and third columns, are extracted and converted into the decimal numbers, 19.2.2.2.2, of two figures. The second data 52a generated by the IPv4 encapsulation includes the IPv4 packet header having the source address of 192.1.1.1 and the destination address of 192.2.2.2.

In the first IPv4 network B, the data is transmitted on the basis of the source and destination addresses of the IPv4 packet header. Specifically, the second IPv4 encapsulated data 52a is transmitted to the second IPv6 transit router 40 connected to the second IPv6 network C which includes the second IPv6 host 20 having the IPv6 address corresponding to the destination address of 192.2.2.2.

The second IPv6 transit router 40 decapsulates the received data 52a and transmits the decapsulated data to the second IPv6 network C. The second IPv4 encapsulated data 52a are transmitted to the second IPv6 network C after the IPv4 packet header has been removed therefrom.

Then, the second IPv6 host 20 receives third data 53a from which the IPv4 packet header has been removed.

In this manner, typically, when the 6 to 4 tunneling process is performed, the IPv4 encapsulation is performed by using the IPv4 address information included in the IPv6 address. Hence, in order to perform the IPv4 encapsulation, the IPv4 address must be included in the IPv6 address.

However, the data to be multicast in the IPv6 network includes only a multicast address of ff02 promised in advance without including the IPv4 address in the destination address. Thus, if the destination address is the multicast address on performing the 6 to 4 tunneling process, the IPv4 encapsulation is impossible. Consequently, there is a drawback in that the IPv6 protocol using the multicast address, for example, Routing Information Protocol next generation (RIPng), Open Shortest Path First v3 (OSPFv3), Protocol Independent Multicast (PIM), Distance Vector Multicast Routing Protocol (DVMRP), Resource ReServation Protocol (RSVP) etc. can not be used with a 6 to 4 tunnel. In other words, when data transmission between the IPv6 and IPv4 networks is performed by using the 6 to 4 tunneling method, there is drawback in that multicasting is impossible

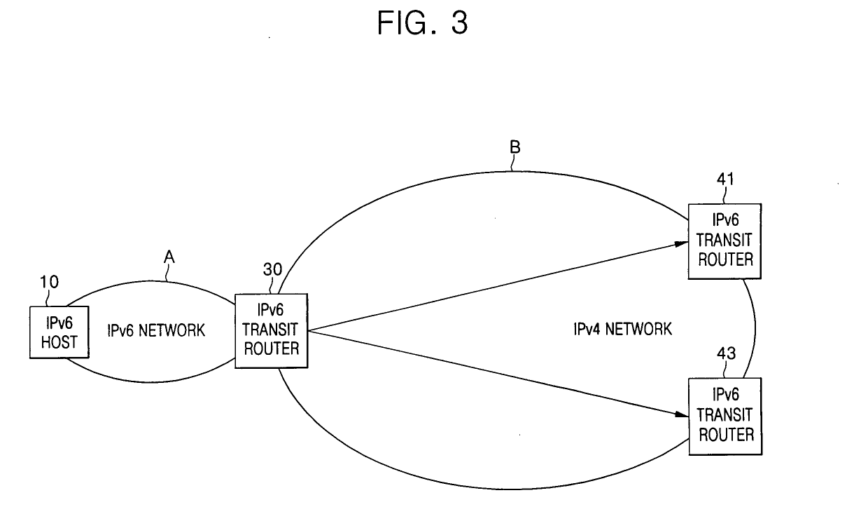

FIG. 3 is a view of multicasting in a IPv6 transit network. Referring to FIG. 3, when a IPv6 host 10 connected to an IPv6 network A intends to multicast data to a plurality of other IPv6 hosts connected to the IPv6 host 10 via an IPv4 network B, an IPv6 transit router 30 arranged at the boundary between the IPv6 network A and the IPv4 network B transmits the multicast data from the IPv6 host 10 to an IPv6 transit router 41 and an IPv6 transit router 43. As mentioned above, the multicast data does not include IPv4 addresses (i.e., the addresses of the IPv6 hosts respectively connected via the IPv6 transit router 41 and the IPv6 transit router 43). Therefore, there is a drawback in that the IPv6 host 10 cannot perform the multicasting using the 6 to 4 tunneling method as illustrated in FIGS. 1 and 2.

Hereinafter, an exemplary embodiment of the present invention will be described in more detail with reference to the accompanying drawings. In describing the present invention, a detailed description of known functions or configurations unnecessarily obscuring the gist of the present invention has been omitted.

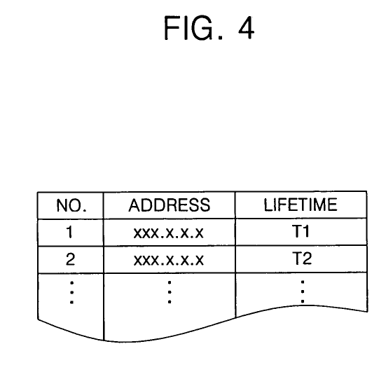

FIG. 4 is a 6 to 4 session entry table according to an embodiment of the present invention. The 6 to 4 session entry table (hereinafter, referred to as “the table”) must be stored in those IPv6 transit routers connected to an IPv6 host intended to perform multicasting among all of the IPv6 transit routers arranged at the boundary between an IPv4 network and an IPv6 network. As shown in FIG. 4, an ‘address’ field and a ‘lifetime’ field are included.

The ‘address’ field is stored with an IPv4 address of the IPv6 host corresponding to a source of a packet received via a 6 to 4 tunnel. In the example of FIG. 3, the ‘address’ field of the table stored in the IPv6 transit router 30 arranged at the boundary between the IPv6 network A and the IPv4 network B is stored with the IPv4 address of the IPv6 host corresponding to a source of a packet received via the 6 to 4 tunnel. In other words, the IPv4 addresses of the IPv6 hosts that are respectively connected to the IPv6 transit routers 41 and 43 are stored.

The ‘lifetime’ field is stored with time information (e.g., in units of seconds) anticipating that the IPv6 host corresponding to the IPv4 address stored in the corresponding ‘address’ field is connected to the network. The time information is periodically decreased in value. Specifically, the ‘lifetime’ begins with a predetermined value when the corresponding entry is registered with the table and then is periodically decreased in value. For instance, when the period is 1 (one) second, the lifetimes of all entries stored in the table are decreased by ‘1 (one).’ If the value of the ‘lifetime’ becomes ‘0(zero),’ it is determined that the corresponding IPv6 host no longer needs to perform communication, and thus the entry is deleted from the table.

To be specific, when a packet adopting the IPv4 address of a certain 6 to 4 session entry as the source address is not received through the 6 to 4 tunnel for the lifetime, the corresponding session entry is considered to be a connection where communication is no longer to be performed, and is thus deleted. The corresponding IPv6 transit router no longer transmits the multicast packet with the IPv4 address corresponding to the deleted entry.

It is preferable that the ‘lifetime is adapted to allow a user to set an initial value and to use a previously set value for each IPv6 protocol. For example, when the protocol to be used via the 6 to 4 tunnel is Open Shortest Path First v3 (OSPFv3) and when a hello packet transmission period of the OSPFv3 is 10 seconds, a default value of the ‘lifetime’ should be preferably set to at least 10 seconds. Since a timeout for the hello packet of the OSPFv3 is 40 seconds, the default value of the ‘lifetime’ is preferably set to about 40 seconds.

Table 1 compares a value of the hello packet transmission period or the update period and a value of the hold time or the expiration timeout with respect to each protocol.

TABLE 1

| | Protocol | | | | |
|---|---|---|---|---|---|
| | RIPng | OSPFv3 | PIM | DVMRP | RSVP |
| Update Period/ | 30 | 10 | 30 | 60 | 30 |
| Hello Packet | | | | | |
| Transmission | | | | | |
| Period (seconds) | | | | | |
| Hold time/ | 180 | 40 | 105 | 120 | 90 |
| Expiration timeout | | | | | |
| (seconds) | | | | | |
| Multicast Address | ff02::9 | ff02::5 | ff02::13 | ff02::4 | ff02::14 |
| | | ff02::6 | | | |

In general, each protocol has the hello packet transmission period or the update period, wherein information related to the protocol is updated with respect to another router by these periods, and all information on the protocol received from another existing router is deleted when no hello or update message is received for the hold time or expiration timeout. Therefore, the default value of the ‘lifetime’ of the 6 to 4 session entry is preferably used with reference to these values.

If various protocols are operated via the 6 to 4 tunnel, the smaller of the hold time and expiration timeout values is preferably selected. In this case, one or more packets can be received from the IPv4 source address of the 6 to 4 session entry within at least that period, so that the 6 to 4 session entry can be lastingly maintained and the various protocols can all maintain the connection.

For example, when OSPFv3 and PIM are to be operated at the same time, the smaller one, 40 seconds, out of 40 seconds that is the hold time of OSPFv3 and 105 seconds that is the hold time of PIM is preferably set as the default value of the ‘lifetime’ of the 6 to 4 session entry.

Furthermore, the table and a controller to manage the table are preferably included in the respective IPv6 transit routers.

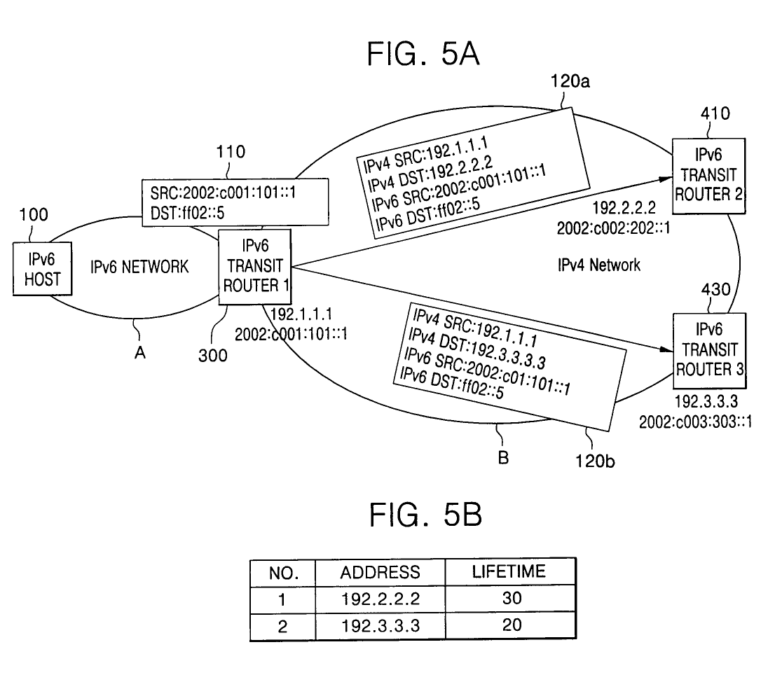

FIGS. 5A and 5B are respectively views for explaining a multicasting method and apparatus in an IPv6 transition network in accordance with one embodiment of the present invention.

Specifically, FIG. 5A is a view for explaining a process of performing multicasting using 6 to 4 tunneling in an IPv6 transition network in accordance with one embodiment of the present invention, and FIG. 5B is a 6 to 4 session entry table (hereinafter, referred to as “the table”) stored in an IPv6 transit router 300 in the example of FIG. 5A.

The process in which the IPv6 transit router 300 performs multicasting to other IPv6 transit routers 410 and 430 via 6 to 4 tunneling will be described with reference to FIGS. 5A and

First, in the example of FIG. 5A, the IPv6 transit router 1 300 performs multicasting to the IPv6 transit router 2 410 and the IPv6 transit router 3 430 using 6 to 4 tunneling in response to a request by an IPv6 host 100. To this end, the IPv6 transit router 1 300 stores the table shown in FIG. 5B. Specifically, the IPv6 transit router 1 300 stores a table including addresses and lifetimes corresponding to all IPv6 hosts intending to perform multicasting via the IPv6 transit router 1 300.

In the example of FIG. 5B, No. 1 entry of the table stores an IPv4 address, 192.2.2.2, of the IPv6 host corresponding to the IPv6 transit router 2 410 and a lifetime, 30, of that IPv6 host, and No. 2 entry of the table stores an IPv4 address, 192.3.3.3, of the IPv6 host corresponding to the IPv6 transit router 3 430 and a lifetime, 20, of that IPv6 host.

Furthermore, in the example of FIG. 5A, the IPv6 host 100 corresponding to the IPv6 transit router 1 300 has an IPv6 address of 2002:c001:101::1, and an IPv4 address of 192.1.1.1, the IPv6 host (not shown) corresponding to the IPv6 transit router 2 410 has an IPv6 address of 2002:c002:202::1, and an IPv4 address of 192.2.2.2, and the IPv6 host (not shown) corresponding to the IPv6 transit router 3 430 has an IPv6 address of 2002:c003:303::1, and an IPv4 address of 192.3.3.3.

When receiving packet data from the IPv6 host 100 via an IPv6 network A, the IPv6 transit router 1 300 extracts source and destination addresses of the corresponding packet data from a header 110 of that packet data. On the basis of the extracted source and destination addresses, a determination is made as to whether or not the corresponding data is to be multicast. In the IPv6 network, the data to be multicast has a destination address fixed to a previously set arbitrary value (e.g. ff02). Thus, the IPv6 transit router 1 300 determines whether or not the destination address included in the header 110 has the value of fff02, and thereby whether or not the data is to be multicast.

As illustrated in FIG. 5A, when the destination address included in the header 110 is not the IPv6 address of each host, ff02, the IPv6 transit router 1 300 searches the table which is stored therein in a form as illustrated in FIG. 5B, and transmits the corresponding packet to the addresses of all entries stored in the table. In other words, the IPv6 transit router 1 300 transmits the packet data received from the IPv6 host 100 using 6 to 4 tunneling with reference to values of the IPv4 addresses stored in the table.

In the example of FIG. 5B, since only two entries are included in the table stored in the IPv6 transit router 1 300, the IPv6 transit router 1 300 adds the packet data received from the IPv6 host 10 to the IPv4 packet header which uses each of those addresses as the destination address, and then transmits the packet data to the corresponding IPv6 transit routers (i.e., the IPv6 transit router 2 410 and the IPv6 transit router 3 430) via an IPv4 network B. Element 120a of FIG. 5A is the header of the packet data transmitted from the IPv6 transit router 1 300 to the IPv6 transit router 2 410, and element 120b is the header of the packet data transmitted from the IPv6 transit router 1 300 to the IPv6 transit router 3 430.

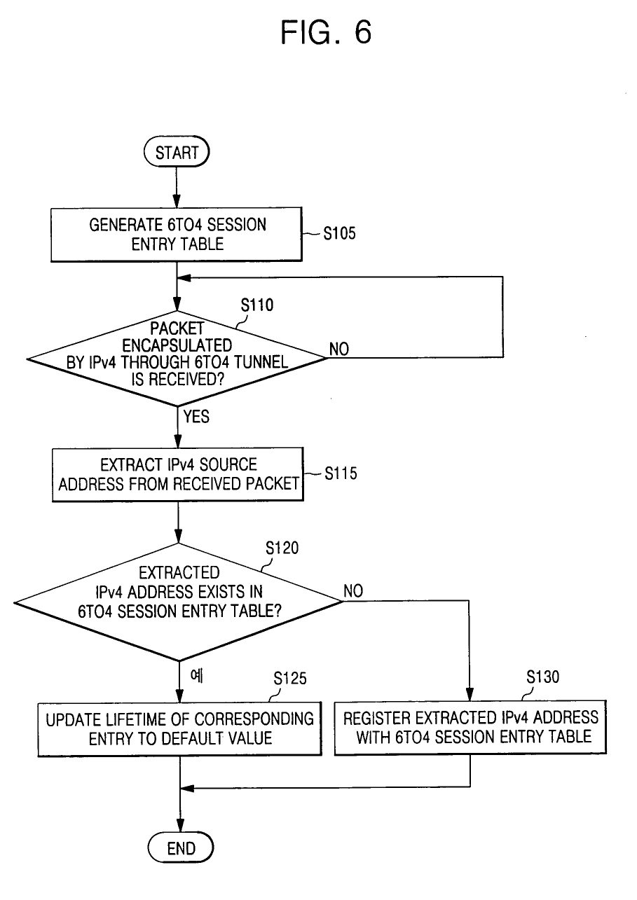

FIG. 6 is a flowchart of a process of generating and managing a 6 to 4 session entry table according to one embodiment of the present invention. In other words, FIG. 6 is a view for explaining a process where each IPv6 transit router arranged on the boundary between an IPv6 network and an IPv4 network generates and manages the 6 to 4 session entry table.

Referring to FIG. 6, the IPv6 transit router arranged on the boundary between the IPv6 network and the IPv4 network first generates the 6 to 4 session entry table (S105). When receiving a packet encapsulated by IPv4 via a 6 to 4 tunnel (S110), the IPv6 transit router extracts an IPv4 source address from the received packet (S115). Then, the IPv6 transit router determines whether or not an entry having the same address as the extracted IPv4 address exists in the 6 to 4 session entry table (S120). As a resulting of the determination (S120), when the entry having the same address as the IPv4 address extracted in the step S115 exists in the 6 to 4 session entry table, the IPv6 transit router updates a lifetime of the corresponding entry into a default value (S125). As a resulting of the determination (S120), when the entry having the same address as the IPv4 address extracted in the step S115 does not exist in the 6 to 4 session entry table, the IPv6 transit router registers the IPv4 address with the 6 to 4 session entry table.

In the example of FIG. 5A, when receiving data encapsulated by IPv4 from the IPv6 transit router 2 410, the IPv6 transit router 1 300 extracts an IPv4 source address, 192.2.2.2, of the data. In other words, the IPv6 transit router 1 300 extracts an IPv4 source address, 192.2.2.2, of the IPv6 host corresponding to the IPv6 transit router 2 410. The IPv6 transit router 1 300 then determines whether or not any entry coinciding with the IPv4 address exists in the previously stored 6 to 4 session entry table.

Referring to the 6 to 4 session entry table illustrated in FIG. 5B, the address of 192.2.2.2 has been already registered with the 6 to 4 session entry table of the IPv6 transit router 1 300. Thus, the IPv6 transit router 1 300 updates a lifetime corresponding to the address to a default value. When the IPv6 network uses the OSPFv3 protocol, the default value of the lifetime is preferably set to 40. Thus, the lifetime is preferably updated to 40.

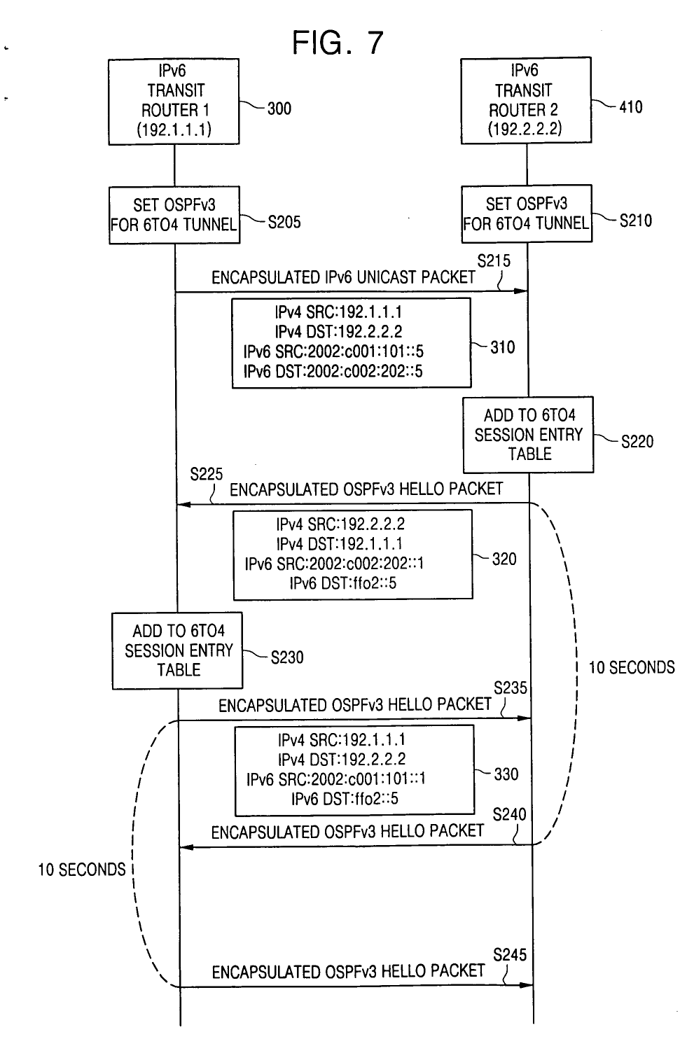

FIG. 7 is a procedural diagram for explaining in more detail a process of generating and managing a 6 to 4 session entry table of the present invention using the OSPFv3 protocol. FIG. 7 shows a process of generating and managing each 6 to 4 session entry table by an IPv6 transit router 1 300 and an IPv6 transit router 2 410, each of which transmits and receives a packet via a 6 to 4 tunnel, wherein the IPv6 transit router 1 300 has an IPv4 address of a corresponding host as 192.1.1.1, and the IPv6 transit router 2 410 has an IPv4 address as 192.2.2.2.

Referring to FIG. 7, first, the IPv6 transit router 1 300 and the IPv6 transit router 2 410 set a protocol for transmitting data to each other. In the example of FIG. 7, the IPv6 transit router 1 300 and the IPv6 transit router 2 410 each set the OSPFv3 protocol (S205 and S210). In more detail, a process for setting the protocol uses a general method of setting a protocol. For this reason, a detailed description of the process has been omitted.

As set forth above, the IPv6 transit router 1 300 and the IPv6 transit router 2 410 set the protocol. Thereafter, when the IPv6 transit router 1 300 transmits an encapsulated IPv6 unicast packet to the IPv6 transit router 2 410 (S215), the IPv6 transit router 2 410 adds a value, 192.1.1.1, of an IPv4 source address included in the received packet to the 6 to 4 session entry table of the IPv6 transit router 2 410 (S220). Element 310 of FIG. 7 denotes information on a header of the packet transmitted in this process S215.

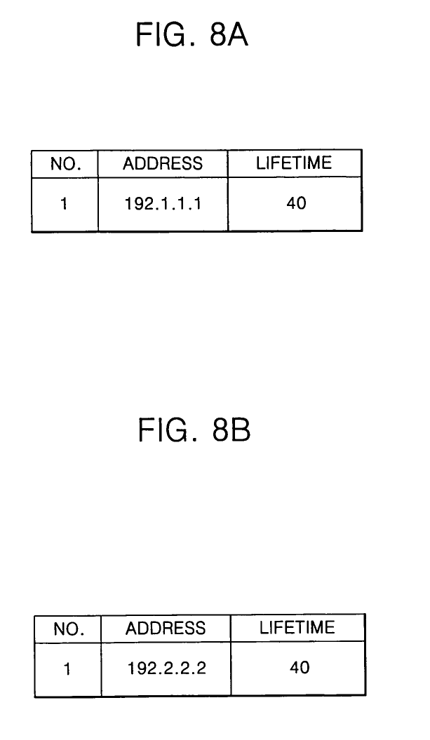

FIG. 8A is an example of the 6 to 4 session entry table stored in the IPv6 transit router 2 410 as a result of performing the process S220. Referring to FIG. 8A, for the table, a source address, 192.1.1.1, of the packet data received in the process S215 is stored in an address field, and a hold time, 40 seconds, of the OSPFv3 protocol is stored in an lifetime field.

When the IPv6 transit router 2 410 configuring the 6 to 4 session entry table in this manner receives data for multicasting, the IPv6 transit router 2 410 encapsulates the corresponding data with reference to the 6 to 4 session entry table and then transmits the encapsulated OSPFv3 hello packet to the IPv6 transit router 1 300 (S225). Element 320 of FIG. 7 denotes information on a header of the packet transmitted at this time.

The IPv6 transit router 1 300 receiving the packet transmitted from the IPv6 transit router 2 410 in the process S225 adds a value of the IPv4 source address included in the received packet to the 6 to 4 session entry table of the IPv6 transit router 1 300 (S230).

FIG. 8B is an example of the 6 to 4 session entry table stored in the IPv6 transit router 1 300 as a result of performing the process S230. Referring to FIG. 8B, for the table, a source address, 192.2.2.2, of the packet data received in the process S225 is stored in an address field of the table, and a hold time, 40 seconds, of the OSPFv3 protocol is stored in an lifetime field.

When the IPv6 transit router 1 300 configuring the 6 to 4 session entry table in this manner receives data for multicasting, the IPv6 transit router 1 300 encapsulates the corresponding data with reference to the 6 to 4 session entry table and then transmits the encapsulated OSPFv3 hello packet to the IPv6 transit router 2 410 (S235). Element 330 of FIG. 7 denotes information on a header of the packet transmitted at this time.

As illustrated in Table 1, the hello packet transmission period of the OSPFv3 protocol is 10 seconds. Hence, the IPv6 transit router 2 410 transmits the hello packet to the IPv6 transit router 1 300 in the process S225, and again transmits the hello packet to the IPv6 transit router 1 300 after 10 seconds (S240). Furthermore, the IPv6 transit router 1 300 similarly transmits the hello packet to the IPv6 transit router 2 410 in the process S235, and again transmits the hello packet to the IPv6 transit router 2 410 after 10 seconds (S245).

When the IPv6 transit router 1 300 receives the hello packet in the process 240 while periodically reducing the lifetime of the corresponding entry which is added to the 6 to 4 session entry table in the process S230, the IPv6 transit router 1 300 updates the lifetime to a default value (e.g., 40 seconds for OSPFv3).

Furthermore, when the IPv6 transit router 2 410 receives the hello packet in the process 245 while periodically reducing the lifetime of the corresponding entry which is added to the 6 to 4 session entry table in the process S220, the IPv6 transit router 2 410 updates the lifetime to a default value (e.g., 40 seconds for OSPFv3).

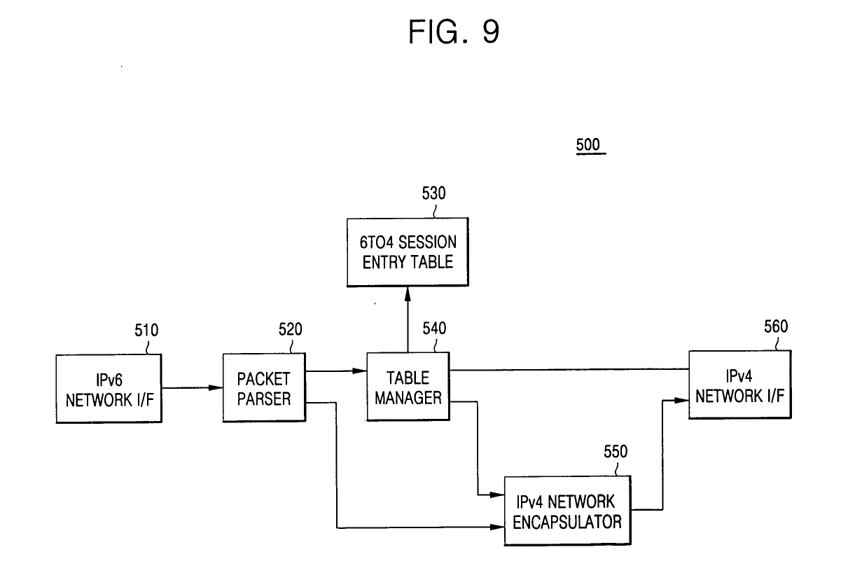

FIG. 9 is a block diagram of a multicasting apparatus in an IPv6 transition network according to one embodiment of the present invention. Referring to FIG. 9, the multicasting apparatus 500 in the IPv6 transition network according to one embodiment of the present invention includes an IPv6 network interface (I/F) 510, a packet parser 520, a 6 to 4 session entry table 530, a table manager 540, an IPv4 encapsulator 550 and an IPv4 network I/F 560.

The IPv6 network I/F 510 performs interfacing with an IPv6 network, and the IPv4 network I/F 560 performs interfacing with an IPv4 network.

The 6 to 4 session entry table 530 stores and manages information for multicasting data, which are transmitted from the IPv6 network to the IPv4 network. The 6 to 4 session entry table 530 stores and manages a lifetime corresponding to an IPv4 address of an IPv6 host intended to receive the data to be multicast. The 6 to 4 session entry table 530 has been described in detail with reference to FIG. 4, and a detailed description thereof has been omitted.

The table manager 540 performs general management of the 6 to 4 session entry table 530, such as adding a new entry, updating information of an old entry stored previously, and deleting the information of the old entry stored previously, with respect to the 6 to 4 session entry table 530.

More particularly, when IPv4 encapsulated packet data has been received via the IPv4 network I/F 560, the table manager 540 determines whether the same address as an IPv4 source address of the packet data is stored in the 6 to 4 session entry table 530, and manages the 6 to 4 session entry table 530 on the basis of the determination result. Specifically, when the same address as the IPv4 source address of the packet data is stored in the 6 to 4 session entry table 530, a lifetime of the entry of the 6 to 4 session entry table 530 is updated to a default value. If not, a new entry is added on the basis of information on the IPv4 source address. In this case, the lifetime of the added entry is set to the default value.

The IPv4 encapsulator 550 performs IPv4 encapsulation to the IPv6 packet data received through the IPv6 network I/F 510, and transmits the IPv4 encapulated data to the IPv4 network I/F 560.

When the IPv6 packet data is received from the IPv6 network I/F 510, the packet parser 520 determines whether or not the corresponding data is multicasting data by parsing a destination address of the data.

When the corresponding data is not multicasting data, the packet parser 520 yields an IPv4 destination address on the basis of an IPv6 destination address included in a header of the data packet, and transmits the yielded result to the IPv4 encapsulator 550.

However, when the IPv6 packet data received from the IPv6 network I/F 510 is multicasting data as a result of the determination, the packet parser 520 transmits that information to the table manager 540 to detect Information on the IPv4 address from the 6 to 4 session entry table 530, and then transmits the IPv4 address information to the IPv4 encapsulator 550. When a plurality of entries are stored in the 6 to 4 session entry table 530, the table manager 540 detects all of the IPv4 address information corresponding to each of the entries and transmits the detected information to the IPv4 encapsulator 550.

Then, the IPv4 encapsulator 550 performs IPv4 encapsulation to the IPv6 packet data received from the IPv6 network I/F 510 on the basis of the IPv4 address information transmitted via the packet parser 520 or the table manager 540, and then transmits the IPv4 encapsulated data to the IPv4 network I/F 560.

This multicasting tunneling apparatus according to the present invention is preferably implemented with routers arranged on the boundary between the IPv6 network and the IPv4 network.

Although the exemplary embodiments of the present invention have been described, it is natural that various changes and modification can be made within the spirit and scope of the present invention. In particular, the detailed description has been made on, but not limited to, the multicasting tunneling method in the IPv6 transition network by way of example. In other words, the present invention is directed to the apparatus and method of multicasting between the networks having address formats different from each other on the basis of a previously set session entry table. Therefore, the scope of the present invention is not limited to the described embodiments, but rather is defined by the following claims.

The present invention as mentioned above has an advantage in that it is capable of performing multicasting between networks having address formats different from each other by referring to the session entry table storing and managing multicasting address information between the networks having address formats different from each other. Particularly, it has another advantage in that it is capable of multicasting using the 6 to 4 tunnel. Furthermore, the present invention is capable of reducing unnecessary traffic by no longer performing multicasting to some, which do not perform communication for a given time, among from entries stored in the session entry table.

What is claimed is:

1. A method comprising:
managing a session entry table for storing information used for multicasting data transmitted from a first network having a first address format to a second network having a second address format different from the first address format; and
tunneling multicasting data, generated by the first network, to the second network in accordance with the session entry table.

2. The method of claim 1, wherein managing the session entry table comprises detecting second address format source addresses of packet data and storing the detected second address format addresses in the session entry table upon a router arranged on a boundary between the first network and the second network receiving the packet data from the second network.

3. The method of claim 2, wherein managing the session entry table comprises storing together lifetimes of hosts corresponding to the second address format addresses in the session entry.

4. The method of claim 3, wherein managing the session entry table comprises setting default values of the lifetimes in accordance with a value of a hello packet transmission period or an update period and a value of a hold time or an expiration timeout with respect to a multicasting protocol.

5. The method of claim 4, wherein managing the session entry table comprises setting the default values of the lifetimes within a range greater than the hello packet transmission period or the update period and smaller than the hold time or the expiration timeout.

6. The method of claim 4, wherein managing the session entry table comprises setting the default values of the lifetimes to the value of the hold time or the expiration timeout.

7. The method of claim 3, wherein managing the session entry table comprises decreasing the lifetimes by periods, and deleting a corresponding entry from the session entry table upon the lifetimes having a value of ‘0(zero)’.

8. The method of claim 3, wherein managing the session entry table comprises updating lifetimes corresponding to the source addresses to default values upon the detected source addresses already existing in the session entry table.

9. The method of claim 2, wherein tunneling the multicasting data comprises encapsulating the multicasting data by the number of entries included in the session entry table by adopting each of the second address format addresses stored in the session entry table as a destination address, and then multicasting each of the encapsulated data to the corresponding format address.

10. A method comprising:
managing a 6 to 4 session entry table for storing information used for multicasting data transmitted from an Internet Protocol version 6 (IPv6) network to an Internet Protocol version 4 (IPv4) network; and
tunneling the multicasting data to the IPv4 network in accordance with the 6 to 4 session entry table upon multicasting data being generated by the IPv6 network.

11. The method of claim 10, wherein managing the 6 to 4 session entry table comprises detecting IPv4 source addresses of packet data and storing the detected IPv4 addresses in the 6 to 4 session entry table upon a router arranged on a boundary between the IPv6 network and the IPv4 network receiving the packet data from the IPv4 network.

12. The method of claim 11, wherein managing the 6 to 4 session entry table comprises storing together lifetimes of hosts corresponding to the IPv4 addresses in the 6 to 4 session entry.

13. The method of claim 12, wherein managing the 6 to 4 session entry table comprises setting default values of the lifetimes in accordance with a value of a hello packet transmission period or an update period and a value of a hold time or an expiration timeout with respect to a multicasting protocol.

14. The method of claim 13, wherein managing the 6 to 4 session entry table comprises setting the default values of the lifetimes within a range greater than the hello packet transmission period or the update period and smaller than the hold time or the expiration timeout.

15. The method of claim 13, wherein managing the 6 to 4 session entry table comprises setting the default values of the lifetimes to the value of the hold time or the expiration timeout.

16. The method of claim 12, wherein managing the 6 to 4 session entry table comprises decreasing the lifetimes by periods and deleting a corresponding entry from the 6 to 4 session entry table upon the lifetimes having a value of ‘0(zero)’.

17. The method of claim 12, wherein managing the 6 to 4 session entry table comprises updating lifetimes corresponding to the IPv4 addresses to default values upon the detected IPv4 addresses already existing in the 6 to 4 session entry table.

18. The method of claim 11, wherein tunneling the multicasting data comprises performing IPv4 encapsulation of the multicasting data by the number of entries included in the 6 to 4 session entry table by adopting each of the IPv4 addresses stored in the 6 to 4 session entry table as a destination address, and then multicasting each of the IPv4 encapsulated data to the corresponding IPv4 address.

19. An apparatus comprising:
a first interface adapted to interface with a first network having a first address format;
a second interface adapted to interface with a second network having a second address format;
a session entry table adapted to store information used for multicasting data transmitted from the first network to the second network;
a table manager adapted to add a new entry, and to update and delete information of a previously stored old entry, with respect to the session entry table in accordance with information of the data transmitted and received via the first and second interfaces;
an encapsulator adapted to encapsulate data of the first address format into data of the second address format to transmit the data from the first network to the second network; and
a packet parser adapted to determine whether or not the data received via the first interface is multicasting data, and controlling the encapsulator and the table manager in accordance with the determination result.

20. The apparatus of claim 19, wherein the session entry table comprises a field for addresses of the second address format that are source addresses of the data received via the second interface, and a lifetime field for lifetimes of hosts corresponding to the addresses.

21. The apparatus of claim 20, wherein the lifetime field is adapted to store values set in accordance with a value of a hello packet transmission period or an update period and a value of a hold time or an expiration timeout with respect to a multicasting protocol, the set values being stored as default values of the lifetimes.

22. The apparatus of claim 21, wherein the lifetime field is adapted to store values set within a range greater than the hello packet transmission period or the update period and smaller than the hold time or the expiration timeout, the set values being stored as default values of the lifetimes.

23. The apparatus of claim 21, wherein the lifetime field is adapted to store the value of the hold time or the expiration timeout as the default value of the lifetime.

24. The apparatus of claim 20, wherein the table manager is adapted to decrease the lifetimes stored in the lifetime field by periods and delete a corresponding entry from the session entry table upon the lifetimes having a value of ‘0(zero)’.

25. The apparatus of claim 20, wherein the table manager is adapted to detect the source addresses from the data received via the second interface, and to add the detected source addresses and the lifetimes of hosts corresponding to the source addresses to the session entry table.

26. The apparatus of claim 20, wherein the table manager is adapted to detect the source addresses from the data received via the second interface and to update lifetimes corresponding to the source addresses to default values upon the detected source addresses already existing in the session entry table.

27. The apparatus of claim 19, wherein the packet parser is adapted to parse destination addresses of the data received via the first interface to determine whether or not the received data is multicasting data.

28. The apparatus of claim 27, wherein the packet parser is adapted to control operation of the table manager to allow the table manager to detect all of the addresses stored in the session entry table from the session entry table and to then transmit the addresses to the encapsulator upon the data received via the first interface being multicasting data,.

29. The apparatus of claim 28, wherein the encapsulator is adapted to generate encapsulation data adopting all of the addresses transmitted via the table manager as the destination addresses with respect to the transmitted addresses and to transmit the generated encapsulation data to the second interface.

30. An apparatus comprising:
a first interface adapted to interface with an Internet protocol version 6 (IPv6) network;
a second interface adapted to interface with an Internet protocol version 4 (IPv4) network;
a 6 to 4 session entry table adapted to store information used for multicasting data transmitted from the IPv6 network to the IPv4 network;
a table manager adapted to add a new entry and update and delete information of a previously stored old entry, with respect to the 6 to 4 session entry table in accordance with information of the data transmitted and received via the first and second interfaces;
an encapsulator adapted to encapsulate data of an IPv6 format into data of an IPv4 format to transmit the data from the IPv6 network to the IPv4 network; and
a packet parser adapted to determine whether or not the data received via the first interface is multicasting data, and to control the encapsulator and the table manager in accordance with the determination result.

31. The apparatus of claim 30, wherein the 6 to 4 session entry table comprises an address field adapted to store the IPv4 addresses that are source addresses of the data received through the second interface, and a lifetime field for lifetimes of hosts corresponding to the IPv4 addresses.

32. The apparatus of claim 31, wherein the lifetime field is adapted to store values set in accordance with a value of a hello packet transmission period or an update period and a value of a hold time or an expiration timeout with respect to a multicasting protocol, the set values being stored as default values of the lifetimes.

33. The apparatus of claim 32, wherein the lifetime field is adapted to store values set within a range greater than the hello packet transmission period or the update period and smaller than the hold time or the expiration timeout, the set values being stored as the default values of the lifetimes.

34. The apparatus of claim 32, wherein the lifetime field is adapted to store the value of the hold time or the expiration timeout as the default value of the lifetime.

35. The apparatus of claim 31, wherein the table manager is adapted to decrease the lifetimes stored in the lifetime field by periods and to delete a corresponding entry from the 6 to 4 session entry table upon the lifetimes having a value of ‘0(zero)’.

36. The apparatus of claim 31, wherein the table manager is adapted to detect the IPv4 addresses of sources from the data received via the second interface, and to add the detected IPv4 addresses and the lifetimes of hosts corresponding to the IPv4 addresses to the 6 to 4 session entry table.

37. The apparatus of claim 36, wherein the table manager is adapted to detect the IPv4 addresses of the sources from the data received via the second interface and to update lifetimes corresponding to the IPv4 addresses to default values upon the detected IPv4 addresses already existing in the 6 to 4 session entry table.

38. The apparatus of claim 30, wherein the packet parser is adapted to parse destination addresses of the data received via the first interface to determine whether or not the received data is multicasting data.

39. The apparatus of claim 38, wherein the packet parser is adapted to control operation of the table manager to allow the table manager to detect all of the IPv4 addresses stored in the 6 to 4 session entry table from the 6 to 4 session entry table and then transmit the IPv4 addresses to the encapsulator upon the data received via the first interface being multicasting data.

40. The apparatus of claim 39, wherein the encapsulator is adapted to generate encapsulation data adopting all of the IPv4 addresses transmitted via the table manager as the destination addresses with respect to the transmitted IPv4 addresses and to transmit the generated encapsulation data to the second interface.
